(19) United States
(12) Patent Application Publication
(10) Pub. No.: US 2022/0245196 A1
(43) Pub. Date: Aug. 4, 2022

(54) INFORMATION DISPLAYING METHOD AND APPARATUS, AND STORAGE MEDIUM

(71) Applicant: BEIJING BYTEDANCE NETWORK TECHNOLOGY CO., LTD., Beijing (CN)

(72) Inventor: Guoliang ZHAO, Beijing (CN)

(21) Appl. No.: 17/614,927

(22) PCT Filed: May 29, 2020
(86) PCT No.: PCT/CN2020/093336

§ 371 Date: Nov. 29, 2021

(30) Foreign Application Priority Data
May 30, 2019 (CN) 201910461664.0

(51) Int. Cl. G06F 16/904; G06F 40/106; G06F 40/177; G06F 3/0481

(52) U.S. Cl. CPC G06F 16/904; G06F 3/0481; G06F 40/177; G06F 40/106

(57) ABSTRACT

Embodiments of the present disclosure disclose an information displaying method and apparatus, and storage medium. The information display method comprises: acquiring the maximum number of views displayed in a preset row and the number of preset rows in a preset display region according to preset layout requirements; combining the same number of views as the maximum views displayed in the preset row into one row chain; constructing the same number of row chains as the preset row to obtain display row chains, while displaying information among various row chains of the display row chains by position constraint; and displaying information to be displayed in the display row chains based on the maximum number of views displayed in the preset row when the information to be displayed is acquired.

### CROSS-REFERENCE TO RELATED APPLICATIONS

This application is filed based on the Chinese patent application No. 201910461664.0 with a filing date of May 30, 2019 and a title of “Information Displaying Method and Apparatus, and Storage Medium”, and claims priority to the Chinese Patent Application. All contents of the Chinese Patent Application are incorporated herein by reference.

### TECHNICAL FIELD

The present disclosure relates to information processing technologies in the field of information technologies, in particular to an information displaying method and apparatus, and storage medium.

### BACKGROUND ART

Information flow refers to an information presentation mode in which users can continuously view information by continuously scrolling the screen, and is widely applied to message display scenes, such as social information flow in Wechat Moments. However, the process of forming the information flow usually involves the messages to be displayed that carry the information to be displayed (such as images). How to lay out the display of the information to be displayed is an important part of displaying the messages to be displayed.

In the prior art, when the information to be displayed at least includes one piece of information, the information to be displayed is usually displayed by laying out the information in a nesting mode. However, when the information to be displayed is displayed in the nesting mode, the information to be displayed is high in interconnectedness, complex in display mode and easy to have errors during display; and more time and power are consumed by an information display device to draw views. Therefore, the existing display mode of the information to be displayed is high in complexity, low in robustness, low in efficiency and high in power consumption.

### SUMMARY OF THE INVENTION

Embodiments of the present disclosure provide an information display method, an information display device and a storage medium.

The technical scheme of this disclosure is realized in this way:

On the first aspect, embodiments of the present disclosure provide an information display method, which is characterized by comprising:

acquiring the maximum number of views displayed in a preset row and the number of preset rows in a preset display region according to preset layout requirements;

combining the same number of views as the maximum views displayed in the preset row into one row chain;

constructing the same number of row chains as the preset row to obtain display row chains, wherein information is displayed among various row chains of the display row chains by position constraint; and

displaying information to be displayed in the display row chains based on the maximum number of views displayed in the preset row when the information to be displayed is acquired.

In some embodiments, the step of displaying information to be displayed in the display row chains based on the maximum number of views displayed in the preset row comprises:

determining the quantity of information in the information to be displayed according to preset minimum displaying units;

acquiring a first result of dividing the quantity of information by the maximum number of views displayed in the preset row; and

distributing the information to be displayed to a first sub-display row chain of the display row chains for display based on the first result, and setting display states of the views without displaying information in the first sub-display row chain and the views in a second sub-display row chain, thereby displaying the information to be displayed in the display row chains, wherein the second sub-display row chain represents the remaining row chains in the display row chains other than the first sub-display row chain.

In some embodiments, the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:

when the first result is an integer, acquiring the same number of row chains as the first result from the display row chains to obtain the first sub-display row chain;

sequentially distributing the same quantity of information as the information in the information to be displayed in each row chain of the first sub-display row chain uniformly to obtain sub-information to be displayed corresponding to each row chain of the first sub-display row chain;

sequentially distributing the sub-information to be displayed to the same number of views as the maximum views displayed in the preset row of each row chain of the first sub-display row chain uniformly for display; and

setting the views in the second sub-display row chain to a hidden state which indicates that the views are not displayed and a space occupied by the views in the preset display region is not reserved, to complete the setting of the display state, thereby displaying the information to be displayed in the display row chains.

In some embodiments, the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:

when the first result is not an integer and less than one, acquiring one of the row chains from the display row chains to obtain the first sub-display row chain;

sequentially distributing the same quantity of information as the information in the information to be displayed to the same quantity of views as the information in one row chain of the first sub-display row chain for display; and

setting the views without displaying information in the first sub-display row chain and the views in the second sub-display row chain to the hidden state, to complete the setting of the display state, thereby displaying the information to be displayed in the display row chains.

In some embodiments, the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:

when the first result is not an integer and greater than one, rounding up the first result to obtain a second result;

acquiring the same number of row chains as the second result from the display row chains to obtain the first sub-display row chain;

acquiring a third result of dividing the quantity of information by the second result; and

distributing the information to be displayed to the first sub-display row chain for display according to the third result, and setting the display states of the views without displaying information in the first sub-display row chain and the views in the second sub-display row chain, thereby displaying the information to be displayed in the display row chains.

In some embodiments, the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:

when the third result is an integer, sequentially distributing the same quantity of information as the information in the information to be displayed in each row chain of the first sub-display row chain uniformly to obtain the sub-information to be displayed corresponding to each row chain of the first sub-display row chain;

sequentially distributing the information to be displayed to the same number of views as the third result of each row chain of the first sub-display row chain for display; and

setting the views without displaying information in the first sub-display row chain and the views in the second sub-display row chain to the hidden state, to complete the setting of the display state, thereby displaying the information to be displayed in the display row chains.

In some embodiments, the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:

when the third result is not an integer, sequentially distributing each piece of information in the information to be displayed to each view in each row chain of the first sub-display row chain for display;

setting the views without displaying information in the first sub-display row chain to an invisible state and setting the views in the second sub-display row chain to the hidden state, to complete the setting of the display state, thereby displaying the information to be displayed in the display row chains, wherein the invisible state indicates that the views are not displayed but the space occupied by the views in the preset display region is reserved.

In some embodiments, the views without displaying information in the first sub-display row chain refer to the remaining views in each row chain of the first sub-display row chain other than a first view and a last view.

In some embodiments, before combining the same number of views as the maximum views displayed in the preset row into one row chain, the method further comprises:

setting a measurement method of the views;

correspondingly, the step of combining the same number of views as the maximum views displayed in the preset row into one row chain comprises:

combining the same number of views as the maximum views displayed in the preset row after the measurement method is set into one row chain.

In some embodiments, the step of displaying the information to be displayed in the display row chains based on the maximum number of views displayed in the preset row comprises:

acquiring the width of the information in the information to be displayed by the measurement method when the information to be displayed is displayed;

setting the height of the information in the information to be displayed according to the width to obtain the set information to be displayed; and

displaying the set information to be displayed in the display row chains based on the maximum number of views displayed in the preset row.

In some embodiments, before combining the same number of views as the maximum views displayed in the preset row into one row chain, the method further comprises:

setting the width of the views as a preset threshold;

correspondingly, the step of combining the same number of views as the maximum views displayed in the preset row into one row chain comprises:

combining the same number of set views as the maximum views displayed in the preset row into one row chain.

On the second aspect, embodiments of the disclosure provide an information display device, which is characterized by comprising:

an acquiring unit, configured to acquire the maximum number of views displayed in a preset row and the number of preset rows in a preset display region according to preset layout requirements;

a combining unit, configured to combine the same number of views as the maximum views displayed in the preset row into one row chain;

a constructing unit, configured to construct the same number of row chains as the preset row to obtain display row chains, wherein information is displayed among various row chains of the display row chains by position constraint; and

a displaying unit, configured to display information to be displayed in the display row chains based on the maximum number of views displayed in the preset row when the information to be displayed is acquired.

In an embodiment, the displaying unit 204 includes:

a determining unit, configured to determine the quantity of information in the information to be displayed according to a preset minimum displaying unit;

a processing unit, configured to acquire a first result of dividing the quantity of information by the maximum number of views displayed in the preset row; and

an information displaying unit, configured to allocate the display of the information to be displayed in a first sub-display row chain in the display row chains based on the first result, and set display states of views without displaying information in the first sub-display row chain and views in a second sub-display row chain, thereby displaying the information to be displayed in the display row chains, wherein the second sub-display row chain represents the remaining row chains in the display row chains other than the first sub-display row chain.

In an embodiment, when the first result is an integer, the information displaying unit is specifically configured to acquire the same number of row chains as the first result from the display row chains to obtain the first sub-display row chain, sequentially distribute the same quantity of information as the information in the information to be displayed in each row chain of the first sub-display row chain uniformly to obtain sub-information to be displayed corresponding to each row chain of the first sub-display row chain, sequentially distribute the sub-information to be displayed to the same number of views as the maximum views displayed in the preset row of each row chain of the first sub-display row chain uniformly for display, set the views in the second sub-display row chain to a hidden state which indicates that the views are not displayed and a space occupied by the views in the preset display region is not reserved, to complete the setting of the display state, thereby displaying the information to be displayed in the display row chains.

In an embodiment, when the first result is not an integer and less than one, the information displaying unit is further specifically configured to acquire one of the row chains from the display row chains to obtain the first sub-display row chain, sequentially distribute the same quantity of information as the information in the information to be displayed to the same quantity of views as the information in one row chain of the first sub-display row chain for display, and set the views without displaying information in the first sub-display row chain and the views in the second sub-display row chain to the hidden state, to complete the setting of the display state, thereby displaying the information to be displayed in the display row chains.

In an embodiment, when the first result is not an integer and greater than one, the information displaying unit is further configured to round up the first result to obtain a second result, acquire the same number of row chains as the second result from the display row chains to obtain the first sub-display row chain, acquire a third result of dividing the quantity of information by the second result, distribute the information to be displayed to the first sub-display row chain for display according to the third result, and set the display states of the views without displaying information in the first sub-display row chain and the views in the second sub-display row chain, thereby displaying the information to be displayed in the display row chains.

In an embodiment, when the third result is an integer, the information displaying unit is further specifically configured to sequentially distribute the same quantity of information as the information in the information to be displayed in each row chain of the first sub-display row chain uniformly to obtain the sub-information to be displayed corresponding to each row chain of the first sub-display row chain, sequentially distribute the information to be displayed to the same number of views as the third result of each row chain of the first sub-display row chain for display, and set the views without displaying information in the first sub-display row chain and the views in the second sub-display row chain to the hidden state, to complete the setting of the display state, thereby displaying the information to be displayed in the display row chains.

In an embodiment, when the third result is not an integer, the information displaying unit is further specifically configured to sequentially distribute each piece of information in the information to be displayed to each view in each row chain of the first sub-display row chain for display, set the views without displaying information in the first sub-display row chain to an invisible state which indicates that the views are not displayed but the space occupied by the views in the preset display region is reserved, and set the views in the second sub-display row chain to the hidden state, to complete the setting of the display state, thereby displaying the information to be displayed in the display row chains.

In an embodiment, the views without displaying information in the first sub-display row chain refer to the remaining views in each row chain of the first sub-display row chain other than a first view and a last view.

In an embodiment, the information display device further includes a first setting unit, configured to set a measurement method of the views.

Correspondingly, the combining unit is configured to combine the same number of views as the maximum views displayed in the preset row after the measurement method is combined into one row chain.

In an embodiment, when the information to be displayed is displayed, the displaying unit is specifically used to acquire the width of the information in the information to be displayed by the measurement method, set the height of the information in the information to be displayed according to the width to obtain the set information to be displayed, and display the set information to be displayed in the display row chains based on the maximum number of views displayed in the preset row.

In an embodiment, the information display device further includes a second setting unit, configured to set the width of the views as a preset threshold.

Correspondingly, the combining unit is configured to combine the same number of set views as the maximum views displayed in the preset row into one row chain.

In the third aspect, embodiment of the disclosure provides an electronic equipment, which is characterized by comprising:

a communication bus, configured to implement communication between a memory and a processor;

the memory, configured to store executable instructions; and

the processor, configured to implement the information display method of embodiment of the disclosure when the executable instructions are executed.

On the fourth aspect, embodiment of the disclosure provides a computer readable storage medium, on which the executable instructions are stored, which is characterized in that, when the executable instructions are executed by the processor, the information display method of embodiment of the disclosure is implemented.

Embodiments of the present disclosure provide an information display method, an information display device and a storage medium, wherein the method includes: firstly, acquiring the maximum number of views displayed in a preset row and the number of preset rows in a preset display region according to preset layout requirements; secondly, combining the same number of views as the maximum views displayed in the preset row into one row chain; thirdly, constructing the same number of row chains as the preset row to obtain display row chains, while displaying information among various row chains of the display row chains by position constraint; and finally, displaying information to be displayed in the display row chains based on the maximum number of views displayed in the preset row when the information to be displayed is acquired. By adopting the above technical implementation scheme, the information to be displayed is displayed in the display row chains based on the maximum number of views displayed in the preset row, while the display row chain refer to an information layout mode constructed by the row chains through position constraint based on the preset layout requirements, so the information to be displayed is low in interconnectedness, simple in display mode and unlikely to have errors during display; and less time and power are consumed by an information display device to draw views. Therefore, the display mode of the information to be displayed is low in complexity, high in robustness, high in efficiency and low in power consumption.

### BRIEF DESCRIPTION OF THE DRAWINGS

FIG. 1 is a structural schematic diagram for implementing electronic equipment 100 according to an embodiment of the present disclosure;

FIG. 2 is an optional structural schematic diagram for implementing an information display device according to an embodiment of the present disclosure;

FIG. 3 is an optional structural schematic diagram for implementing the electronic equipment according to the embodiment of the present disclosure;

FIG. 4 is an optional flow diagram I for implementing an information display method according to the embodiment of the present disclosure;

FIGS. 5a-5i are schematic diagrams for implementing the display of an exemplary information to be displayed according to the embodiment of the present disclosure; and

FIG. 6 is an optional flow diagram II for implementing the information display method according to the embodiment of the present disclosure.

### DETAILED DESCRIPTION OF THE INVENTION

In order to make the objectives, technical solutions, and advantages of the present disclosure clearer, the present disclosure will be further described in detail below in conjunction with the accompanying drawings. The described embodiments should not be regarded as limiting the present disclosure. Those of ordinary skill in the art have not made All other embodiments obtained under the premise of creative labor fall within the protection scope of the present disclosure.

In the following description, “some embodiments” are referred to, which describe a subset of all possible embodiments, but it is understood that “some embodiments” may be the same subset or different subsets of all possible embodiments, and Can be combined with each other without conflict.

Referring now to FIG. 1, FIG. 1 is a schematic structural diagram of an electronic device (for example, the electronic device or the server in FIG. 1) 100 implementing an embodiment of the present disclosure. Electronic devices can be various terminals, including mobile phones, laptops, digital broadcast receivers, personal digital assistants (PDAs, Personal Digital Assistant), tablet computers (PAD), portable multimedia players (PMP, Portable Media Player), and in-car Terminals (such as car navigation terminals) and other mobile terminals and fixed terminals such as digital television (TV), desktop computers, etc. The electronic device shown in FIG. 1 is only an example, and should not bring any limitation to the function and scope of use of the embodiments of the present disclosure.

As shown in FIG. 1, the electronic device 100 may include a processing device (such as a central processing unit, a graphics processor, etc.) 110, which may be based on a program stored in a read-only memory (ROM, Read-Only Memory) 120 or from a storage device 180 is loaded into a random access memory (RAM, Random Access Memory) 130 to execute various appropriate actions and processing. In the RAM 130, various programs and data required for the operation of the electronic device 100 are also stored. The processing device 110, the ROM 120, and the RAM 130 are connected to each other through a bus 140. An input/output (I/O, Input/Output) interface 150 is also connected to the bus 140.

Generally, the following devices can be connected to the I/O interface 150: including input devices 160 such as touch screens, touch pads, keyboards, mice, cameras, microphones, accelerometers, gyroscopes, etc.; including, for example, liquid crystal displays (LCD, Liquid Crystal Display) Output devices 170 such as speakers, vibrators, etc.; storage devices 180 including, for example, magnetic tapes, hard disks, etc.; and communication devices 190. The communication device 190 may allow the electronic device 100 to perform wireless or wired communication with other devices to exchange data. Although FIG. 1 shows an electronic device 100 having various devices, it should be understood that it is not required to implement or have all of the illustrated devices. It may alternatively be implemented or provided with more or fewer devices.

In particular, according to an embodiment of the present disclosure, the process described by the provided flowchart can be implemented as a computer software program. For example, the embodiments of the present disclosure include a computer program product, which includes a computer program carried on a computer-readable medium, and the computer program includes program code for executing the method shown in the flowchart. In such an embodiment, the computer program may be downloaded and installed from the network through the communication device 190, or installed from the storage device 180, or installed from the ROM 120. When the computer program is executed by the processing device 110, the function in the method of the embodiment of the present disclosure is executed.

It should be noted that the above-mentioned computer-readable medium in the embodiments of the present disclosure may be a computer-readable signal medium or a computer-readable storage medium, or any combination of the two. The computer-readable storage medium may include, but is not limited to, an electrical, magnetic, optical, electromagnetic, infrared, or semiconductor system, apparatus, or device, or a combination of any of the above, for example. More specific examples of computer-readable storage media may include, but are not limited to: electrical connections with one or more wires, portable computer disks, hard disks, RAM, ROM, and Erasable Programmable Read-Only Memory (EPROM). Only Memory), flash memory, optical fiber, portable compact disk read-only memory (CD-ROM), optical storage device, magnetic storage device, or any suitable combination of the above.

In the embodiments of the present disclosure, the computer-readable storage medium may be any tangible medium that contains or stores a program, and the program may be used by or in combination with an instruction execution system, apparatus, or device. In the embodiments of the present disclosure, the computer-readable signal medium may include a data signal propagated in a baseband or as a part of a carrier wave, and a computer-readable program code is carried therein. This propagated data signal can take many forms, including but not limited to electromagnetic signals, optical signals, or any suitable combination of the foregoing. The computer-readable signal medium may also be any computer-readable medium other than the computer-readable storage medium, and the computer-readable signal medium may send, propagate, or transmit a program for use by or in combination with the instruction execution system, apparatus, or device. The program code contained on the computer-readable medium can be transmitted by any suitable medium, including wire, optical cable, radio frequency (RF, Radio Frequency), etc., or any suitable combination of the above.

The above-mentioned computer-readable medium may be included in the above-mentioned electronic device 100; or it may exist alone without being assembled into the electronic device 100.

The aforementioned computer-readable medium carries one or more programs, and when the aforementioned one or more programs are executed by the electronic device 100, the electronic device 100 is caused to execute the method provided by the embodiment of the present disclosure.

The computer program code used to perform the operations in the embodiments of the present disclosure may be written in one or more programming languages or a combination thereof. The above-mentioned programming languages include object-oriented programming languages—such as Java, Smalltalk, C++, and Conventional procedural programming language-such as “C” language or similar programming language. The program code can be executed entirely on the user's computer, partly on the user's computer, executed as an independent software package, partly on the user's computer and partly executed on a remote computer, or entirely executed on the remote computer or server. In the case of a remote computer, the remote computer can be connected to the user's computer through any kind of network, including a local area network (LAN, Local Area Network) and a wide area network (WAN, Wide Area Network), or it can be connected to an external computer (For example, use an Internet service provider to connect via the Internet).

The units and/or modules in the electronic devices involved in the embodiments of the present disclosure may be implemented in software or hardware.

In terms of hardware, the units and/or modules of the electronic device implementing the embodiments of the present disclosure can be implemented by one or more application specific integrated circuits (ASIC, Application Specific Integrated Circuit), DSP, programmable logic device (PLD, Programmable Logic Device), Complex Programmable Logic Device (CPLD, Complex Programmable Logic Device), Field-Programmable Gate Array (FPGA, Field-Programmable Gate Array) or other electronic components are used to implement the method provided by the embodiments of the present disclosure.

In terms of software, the unit and/or module in the electronic device that implements the information display method of the embodiment of the present disclosure can be implemented by two or more units,

The following uses software as an example to exemplify the units and/or modules in the device that implements the data processing method of the embodiments of the present disclosure.

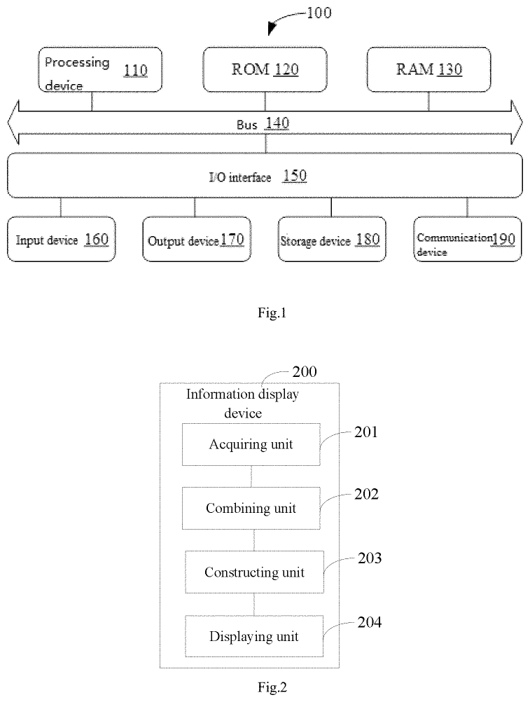

Referring to FIG. 2, FIG. 2 is an optional structural schematic diagram for implementing an information display device according to an embodiment of the present disclosure, and shows the following software modules corresponding to the information display device 200 and stored in a storage device 180:

an acquiring unit 201, configured to acquire the maximum number of views displayed in a preset row and the number of preset rows in a preset display region according to preset layout requirements;

a combining unit 202, configured to combine the same number of views as the maximum views displayed in the preset row into one row chain;

a constructing unit 203, configured to construct the same number of row chains as the preset row to obtain display row chains, wherein information is displayed among various row chains of the display row chains by position constraint; and

a displaying unit 204, configured to display information to be displayed in the display row chains based on the maximum number of views displayed in the preset row when the information to be displayed is acquired.

In an embodiment, the displaying unit 204 includes:

a determining unit 2041, configured to determine the quantity of information in the information to be displayed according to a preset minimum displaying unit;

a processing unit 2042, configured to acquire a first result of dividing the quantity of information by the maximum number of views displayed in the preset row; and

an information displaying unit 2043, configured to allocate the display of the information to be displayed in a first sub-display row chain in the display row chains based on the first result, and set display states of views without displaying information in the first sub-display row chain and views in a second sub-display row chain, thereby displaying the information to be displayed in the display row chains, wherein the second sub-display row chain represents the remaining row chains in the display row chains other than the first sub-display row chain.

In an embodiment, when the first result is an integer, the information displaying unit 2043 is specifically configured to acquire the same number of row chains as the first result from the display row chains to obtain the first sub-display row chain, sequentially distribute the same quantity of information as the information in the information to be displayed in each row chain of the first sub-display row chain uniformly to obtain sub-information to be displayed corresponding to each row chain of the first sub-display row chain, sequentially distribute the sub-information to be displayed to the same number of views as the maximum views displayed in the preset row of each row chain of the first sub-display row chain uniformly for display, set the views in the second sub-display row chain to a hidden state which indicates that the views are not displayed and a space occupied by the views in the preset display region is not reserved, to complete the setting of the display state, thereby displaying the information to be displayed in the display row chains.

In an embodiment, when the first result is not an integer and less than one, the information displaying unit 2043 is further specifically configured to acquire one of the row chains from the display row chains to obtain the first sub-display row chain, sequentially distribute the same quantity of information as the information in the information to be displayed to the same quantity of views as the information in one row chain of the first sub-display row chain for display, and set the views without displaying information in the first sub-display row chain and the views in the second sub-display row chain to the hidden state, to complete the setting of the display state, thereby displaying the information to be displayed in the display row chains.

In an embodiment, when the first result is not an integer and greater than one, the information displaying unit 2043 is further configured to round up the first result to obtain a second result, acquire the same number of row chains as the second result from the display row chains to obtain the first sub-display row chain, acquire a third result of dividing the quantity of information by the second result, distribute the information to be displayed to the first sub-display row chain for display according to the third result, and set the display states of the views without displaying information in the first sub-display row chain and the views in the second sub-display row chain, thereby displaying the information to be displayed in the display row chains.

In an embodiment, when the third result is an integer, the information displaying unit 2043 is further specifically configured to sequentially distribute the same quantity of information as the information in the information to be displayed in each row chain of the first sub-display row chain uniformly to obtain the sub-information to be displayed corresponding to each row chain of the first sub-display row chain, sequentially distribute the information to be displayed to the same number of views as the third result of each row chain of the first sub-display row chain for display, and set the views without displaying information in the first sub-display row chain and the views in the second sub-display row chain to the hidden state, to complete the setting of the display state, thereby displaying the information to be displayed in the display row chains.

In an embodiment, when the third result is not an integer, the information displaying unit 2043 is further specifically configured to sequentially distribute each piece of information in the information to be displayed to each view in each row chain of the first sub-display row chain for display, set the views without displaying information in the first sub-display row chain to an invisible state which indicates that the views are not displayed but the space occupied by the views in the preset display region is reserved, and set the views in the second sub-display row chain to the hidden state, to complete the setting of the display state, thereby displaying the information to be displayed in the display row chains.

In an embodiment, the views without displaying information in the first sub-display row chain refer to the remaining views in each row chain of the first sub-display row chain other than a first view and a last view.

In an embodiment, the information display device further includes a first setting unit 205, configured to set a measurement method of the views.

Correspondingly, the combining unit 202 is configured to combine the same number of views as the maximum views displayed in the preset row after the measurement method is combined into one row chain.

In an embodiment, when the information to be displayed is displayed, the displaying unit 204 is specifically used to acquire the width of the information in the information to be displayed by the measurement method, set the height of the information in the information to be displayed according to the width to obtain the set information to be displayed, and display the set information to be displayed in the display row chains based on the maximum number of views displayed in the preset row.

In an embodiment, the information display device further includes a second setting unit 206, configured to set the width of the views as a preset threshold.

Correspondingly, the combining unit 202 is configured to combine the same number of set views as the maximum views displayed in the preset row into one row chain.

It should be noted that in practical application, the acquiring unit 201, the combining unit 202, the constructing unit 203, the displaying unit 204 (including the determining unit 2041, the processing unit 2042 and the information displaying unit 2043), the first setting unit 205 and the second setting unit 206 can be realized by a processor 301 located on electronic equipment 300, and are particularly realized by a central processing unit (CPU), a microprocessor unit (MPU), a digital signal processing (DSP) or a field programmable gate array (FPGA).

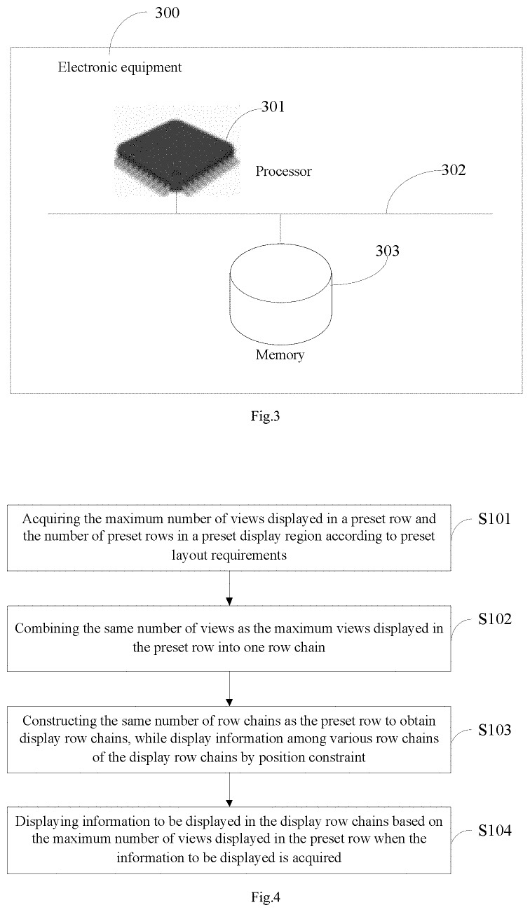

An embodiment of the present disclosure provides electronic equipment 300. As shown in FIG. 3, the electronic equipment 300 includes:

a communication bus 302, configured to implement communication between a memory 303 and a processor 301;

the memory 303, configured to store executable instructions; and

the processor 301, configured to implement the information display method provided by the embodiment of the present disclosure when the executable instructions are executed.

An embodiment of the present disclosure provides a computer readable storage medium on which the executable instructions are stored. When the executable instructions are executed by the processor, the executable instructions are configured to implement the information display method provided by the embodiment of the present disclosure.

It should be pointed out that the above classification of units does not limit the electronic equipment. For example, some units can be split into two or more sub-units; or, some units can be merged into a new unit.

It should also be pointed out that the names of the above units do not limit the units in some cases.

Similarly, the units and/or modules not described in detail in the electronic equipment do not indicate the omission of the corresponding units and/or modules; and all operations performed by the electronic equipment can be implemented by the corresponding units and/or modules in the electronic equipment.

Continuing to refer to FIG. 4, FIG. 4 is an optional flow diagram I for implementing the information display method according to the embodiment of the present disclosure. For example, if a program loaded by a processing device 801 from a read only memory (ROM) 102 or a program loaded from the storage device 180 into the random access memory (RAM) 103 is taken as a client, the process of implementing the information display method provided by the embodiment of the present disclosure at the client in the electronic equipment will be illustrated with the steps shown in FIG. 4. As shown in FIG. 4, the information display method includes:

S101, acquiring the maximum number of views displayed in a preset row and the number of preset rows in a preset display region according to preset layout requirements.

In the embodiment of the present disclosure, a preset layout requirement (such as 3*3 or 4*4 Sudoku) correspondingly exists when the electronic equipment displays information in the preset display region; the preset layout requirement is used for determining an organization arrangement mode of the information to be displayed in the preset display region, so that the electronic equipment can determine the maximum number of views displayed in each row of the preset display region and the maximum number of rows displayed in the preset display region according to the preset layout requirement; and at this moment, the electronic equipment also acquires the maximum number of views displayed in the preset row and the preset number of rows in the preset display region.

It should be noted that the preset display region represents a region for displaying the information, which may be a display screen, a partial display region in the display screen, or other regions capable of displaying the information, and is not specifically limited by the embodiments of the present disclosure. The maximum number of views displayed in the preset row represents the maximum number of views displayed in each row of the preset display region; and the number of preset rows represents the maximum number of rows displayed in preset display region. In addition, the electronic equipment may be a device with a display screen such as a mobile phone, a computer, a mobile internet device or a wearable device, and is not specifically limited by the embodiments of the present disclosure.

Exemplarily, when the preset layout requirement corresponding to the preset display region is 3*3 Sudoku, the electronic equipment can acquire that the number of views displayed in each row is three (the maximum number of views displayed in the preset row) and the number of rows for displaying the views is three (the number of preset rows).

S102, combining the same number of views as the maximum views displayed in the preset row into one row chain.

In the embodiment of the present disclosure, the maximum number of views displayed in the preset row represents the maximum number of views displayed in each row of the preset display region after the electronic equipment acquires the maximum number of views displayed in the preset row, so the electronic equipment can obtain one row by combining the same number of views as the maximum views displayed in the preset row. In addition, the electronic equipment arranges and combines the information by a mode of layout constraint, but a chain is composed of multiple views in the layout constraint and may be a horizontal chain or a vertical chain, so the electronic equipment can combine the maximum number of views displayed in the preset row into one row chain, which is a horizontal chain.

S103, constructing the same number of row chains as the preset row to obtain display row chains, while displaying information among various row chains of the display row chains by position constraint.

In the embodiment of the present disclosure, the preset number of row chains can be created in the preset display region after the electronic equipment determines the row chain and determines that the maximum number of rows displayed in the preset display region is the number of preset rows; and at this moment, the electronic equipment also acquires the display row chains. In addition, the information is displayed by laying out the information among the row chains in the display row chains by position constraint.

It should be noted that the display row chain is an organization arrangement mode of the views determined according to the preset layout requirements; and the display row chains refer to the same number of row chains as the preset row. However, the position constraint represents a mode for determining the own position by setting a relative position with a reference object, wherein the reference object may be a row chain or other information.

Exemplarily, when the electronic equipment determines that one row chain is composed of three (the maximum number of views displayed in the preset row) views and the number of preset rows is three, three row chains can be created, so that the display row chains are obtained. At this moment, each of the three row chains is arranged by position constraint. For example, the layout of a second row chain is implemented by setting a top position of the second row chain to be constrained at the bottom of a first row chain.

S104, displaying information to be displayed in the display row chains based on the maximum number of views displayed in the preset row when the information to be displayed is acquired.

In the embodiment of the present disclosure, when the information to be displayed is present in the preset display region, the electronic equipment acquires the information to be displayed. At this moment, the electronic equipment determines a display position of the information to be displayed in the row chains of the display row chains based on the maximum number of views displayed in the preset row, and displays the information to be displayed in the display row chains, thereby displaying the information to be displayed in the display row chains based on the maximum number of views displayed in the preset row, and thus displaying the information to be displayed in the preset display region.

It should be noted that the information to be displayed represents the information to be displayed in the preset display region, such as images, videos or files.

It is understandable that the electronic equipment constructs the display row chains corresponding to the preset layout requirements by layout constraint, while the information is displayed among various row chains in the display row chains by position constraint, so the electronic equipment displays the information to be displayed in the display row chains, to avoid laying out the information to be displayed in a nesting manner, reduce information redundancy, simplify the process of implementing the information to be displayed, improve the display performance, and also improve the layout flexibility of the information to be displayed.

Further, in the embodiment of the present disclosure, the step S104 of displaying the information to be displayed in the display row chains based on the maximum number of views displayed in the preset row by the electronic equipment specifically includes steps S104a-S104c:

S104a, determining the quantity of information in the information to be displayed according to preset minimum displaying units.

In the embodiment of the present disclosure, the electronic equipment is provided with the preset minimum displaying unit for representing a minimum displaying unit displayed in the preset display region, such as an image, or an image and a paragraph of text. Therefore, when the electronic equipment acquires and displays the information to be displayed, the number of preset minimum displaying units contained in the information to be displayed can be determined according to the preset minimum displaying units, and the quantity of information in the information to be displayed can also be determined.

Exemplarily, when the preset minimum displaying unit is one image and the information to be displayed is three images, the determined quantity of information is three (the number of images in the information to be displayed).

S104b, acquiring the first result of dividing the quantity of information by the maximum number of views displayed in the preset row.

In the embodiment of the present disclosure, when the electronic equipment displays the information to be displayed and after the quantity of information and the maximum number of views displayed in the preset row are acquired, the first result, i.e., the number of row chains occupied when the information to be displayed is displayed in the display row chains is obtained by dividing the quantity of information by the maximum number of views displayed in the preset row, wherein the occupation means that the electronic equipment fills the information in the information to be displayed into the row chains.

It should be noted that the first result represents an accurate result of division operation. For example, when the quantity of information is four and the maximum number of views displayed in the preset row is three, the result is 4/3.

S104c, distributing the information to be displayed to the first sub-display row chain of the display row chains for display based on the first result, and setting display states of the views without displaying information in the first sub-display row chain and the views in the second sub-display row chain, thereby displaying the information to be displayed in the display row chains, wherein the second sub-display row chain represents the remaining row chains in the display row chains other than the first sub-display row chain.

In the embodiment of the present disclosure, the row chains for displaying information to be displayed in the display row chains are determined after the electronic equipment acquires the first result, and is called the first sub-display row chains here, so that the information to be displayed is distributed to the first sub-display row chains for display. In addition, if the remaining row chains exist in the display row chains besides the first sub-display row chains, the remaining row chains in the display row chains other than the first sub-display row chains are called the second sub-display row chains. Obviously, the display row chains are composed of the first sub-display row chains and the second sub-display row chains; and no information is filled into the second sub-display row chains.

It should be noted that each view in the first sub-display row chains is not necessarily filled with information, which is related to the quantity of information and the first result. For the views not filled with information in the first sub-display row chains and the views not filled with information in the second sub-display row chains, the electronic equipment also needs to set the display states, so that the display results of the information to be displayed in the first sub-display row chains can meet the preset layout requirements, thereby displaying the information to be displayed in the display row chains.

Further, the number of row chains specifically contained in the first sub-display row chains is related to the first result; the electronic equipment determines the first sub-display row chains according to the first result, determines the second sub-display row chains according to the determined first sub-display row chains, and sets the display states of the views without displaying information in the first sub-display row chains and the views in the second sub-display row chains, thereby displaying the information to be displayed in the display row chains.

Specifically, the specific execution process of the step S104c in the embodiment of the present disclosure includes technical schemes in three cases. The first one is the technical scheme of displaying the information to be displayed in the display row chains when the first result is an integer, which corresponds to the steps S104c1-S104c4. The second one is the technical scheme of displaying the information to be displayed in the display row chains when the first result is not an integer and less than one, which corresponds to the steps S104c5-S104c7. The third one is the technical scheme of displaying the information to be displayed in the display row chains when the first result is not an integer and greater than one, which corresponds to the steps S104c8-S104c11.

Firstly, when the first result is an integer, the execution steps S104c1-S104c4 of displaying the information to be displayed in the display row chains are as follows:

S104c1, when the first result is an integer, acquiring the same number of row chains as the first result from the display row chains to obtain the first sub-display row chains.

In the embodiment of the present disclosure, after the electronic equipment acquires the first result of dividing the quantity of information by the maximum number of views displayed in the preset row, the first result represents an accurate result and the accurate result may be an integer or non-integer. When the first result is an integer, it is determined that the number of row chains to be occupied by the information to be displayed in the display row chains is the first result, so that the electronic equipment acquires the same number of row chains as the first result from the display row chains, thereby acquiring the row chains to be occupied by the information to be displayed in the display row chains, wherein the row chains to be occupied by the information to be displayed in the display row chains are the first sub-display row chains.

It should be noted that when the electronic equipment selects the same number of row chains as the first result from the display row chains as the first sub-display row chains, the same number of row chains as the first result can be arbitrarily or sequentially selected from the display row chains, which is not specifically limited by the embodiment of the present disclosure.

S104c2, sequentially distributing the same quantity of information as the information in the information to be displayed in each row chain of the first sub-display row chains uniformly to obtain the sub-information to be displayed corresponding to each row chain of the first sub-display row chains.

It should be noted that the sub-information to be displayed represents the information to be displayed in each row chain of the first sub-display row chains. The quantity of sub-information to be displayed is consistent with the number of row chains in the first sub-display row chains; and the sub-information to be displayed corresponds to each row chain of the first sub-display row chains one by one.

S104c3, sequentially distributing the sub-information to be displayed to the same number of views as the maximum views displayed in the preset row of each row chain of the first sub-display row chains for display.

In the embodiment of the present disclosure, the electronic equipment takes each piece of information in the sub-information to be displayed as a preset minimum displaying unit, and sequentially distributes the information to each view in each row chain of the corresponding first sub-display row chain uniformly for display.

It should be noted that each view in each row chain of the first sub-display row chains is used for displaying the preset minimum displaying units, i.e., displaying one piece of information in the corresponding sub-information to be displayed.

Since the result of dividing the quantity of information by the maximum number of views displayed in the preset row is an integer here, the views in each row chain of the first sub-display row chains can be filled with the same quantity of information as the information in the information to be displayed, and the views not filled with the information are absent.

In addition, the same quantity of information as the information in the information to be displayed should be numbered and sorted before implementing the steps S104c2-S104c3.

S104c4, setting the views in the second sub-display row chains to a hidden state which indicates that the views are not displayed and a space occupied by the views in the preset display region is not reserved, to complete the setting of the display state, thereby displaying the information to be displayed in the display row chains.

In the embodiment of the present disclosure, after the electronic equipment displays the information to be displayed in the first sub-display row chains of the display row chains, if the row chains other than the first sub-display row chains, i.e., the second sub-display row chains, exist in the display row chains, no information is filled into the second sub-display row chains, so the electronic equipment sets the views in the second sub-display row chains to the hidden state, and also displays the information to be displayed in the display row chains at this moment.

It should be noted that the hidden state indicates that the views are not displayed and the space occupied by the views in the preset display region is not reserved. For example, a “View” tag (the view) is set to “GONE” (the hidden state).

In addition, if the second sub-display row chains are absent in the display row chains after the electronic equipment displays the information to be displayed in the first sub-display row chains of the display row chains, the step S104c4 is not executed; and the information to be displayed is displayed in the display row chains after the step S104c3 is executed.

Exemplarily, when the display row chains contain three row chains and each row chain is composed of three views,

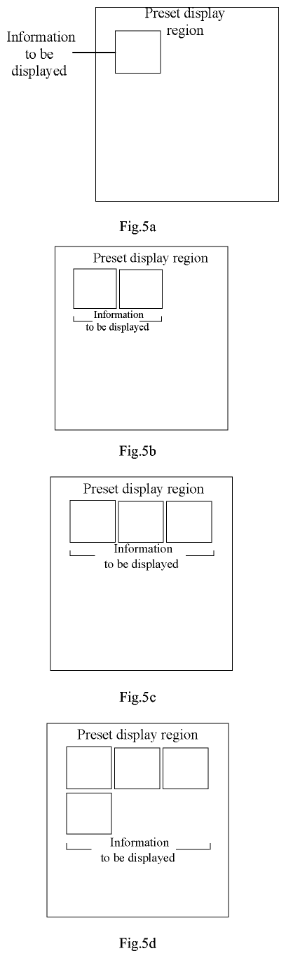

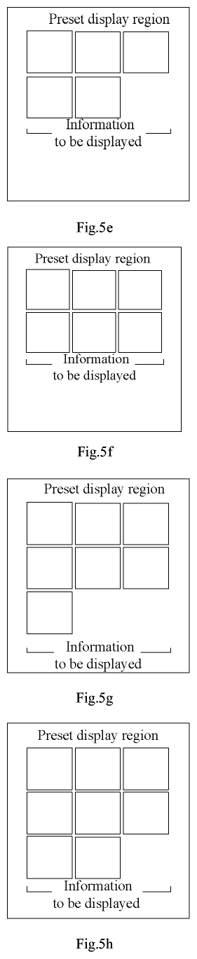

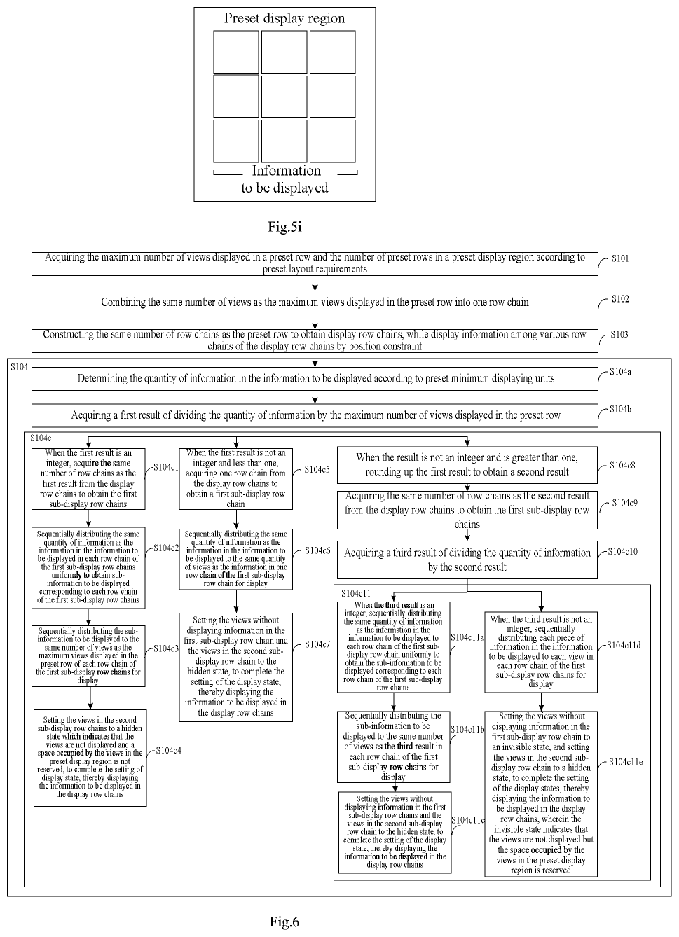

if the information to be displayed acquired by the electronic equipment is three images, the determined quantity of information is three. Since the result of dividing three (the quantity of information) by three (the number of views in the row chains) is one, the electronic equipment selects one row chain (the first sub-display row chain) from the three row chains to display the three images. Specifically, the three images are numbered and sorted and then are sequentially filled into each view in one selected row chain. In addition, the views in the other two unselected row chains (the second sub-display row chains) of the three row chains are set to the hidden state, thereby displaying the three images. The display effect of the information to be displayed is as shown in FIG. 5c.

If the information to be displayed acquired by the electronic equipment is six images, the determined quantity of information is six. Since the result of dividing six (the quantity of information) by three (the number of views in the row chains) is two, the electronic equipment selects two row chains (the first sub-display row chains) from the three row chains to display the six images. Specifically, the six images are numbered and sorted; then, the sub-information to be displayed of each row chain in the two selected row chains (the first one of the two selected row chains is the first three images of the six images, and the second one of the two selected row chains is the last three images of the six images) is determined; and each image in each piece of sub-information to be displayed is filled into each view of the corresponding row chain. In addition, the views in one remaining unselected row chain (the second sub-display row chain) of the three row chains are all set to the hidden state, thereby displaying the six images. The display effect of the information to be displayed is as shown in FIG. 5f.

If the information to be displayed acquired by the electronic equipment is nine images, the determined quantity of information is nine. Since the result of dividing nine (the quantity of information) by three (the number of views in the row chains) is three, the electronic equipment selects three row chains (the first sub-display row chains) from the three row chains to display the nine images Specifically, the nine images are numbered and sorted; then, the sub-information to be displayed of each row chain in the three selected row chains (the first one of the three selected row chains is the first three images of the nine images, the second one of the two selected row chains is the middle three images of the nine images, and the third one of the two selected row chains is the last three images of the nine images) is determined; and each image in each piece of sub-information to be displayed is filled into each view of the corresponding row chain, thereby displaying the nine images. The display effect of the information to be displayed is as shown in FIG. 5i.

So far, the technical scheme of displaying the information to be displayed in the display row chains when the first result is an integer has been completed.

Secondly, when the first result is not an integer and less than one, the execution steps S104c5-S104c7 of displaying the information to be displayed in the display row chains are as follows:

S104c5, when the first result is not an integer and less than one, acquiring one row chain from the display row chains to obtain a first sub-display row chain.

In the embodiment of the present disclosure, after the electronic equipment acquires the first result of dividing the quantity of information by the maximum number of views displayed in the preset row, if the first result is non-integer, i.e., when the first result is not an integer, an information device compares the first result with one to determine a specific display mode of the information to be displayed in the display row chains. The electronic equipment displays the information to be displayed when the first result is not an integer in two cases here. The cases are classified by judging whether the first result is less than one, thereby obtaining the two cases that the first result is less than one and the first result is greater than one.

If a judgment result obtained by the electronic equipment to judge whether the first result is less than one indicates that the first result is less than one here, i.e., when the first result is not an integer and less than one, it is indicated that the number of row chains to be occupied by the information to be displayed in the display row chains is one, so that the electronic equipment acquires one row chain from the display row chains, thereby acquiring the row chain to be occupied by the information to be displayed in the display row chains, i.e., the first sub-display row chain, wherein the first sub-display row chain contains one row chain.

It should be noted that when the electronic equipment selects one row chain from the display row chains as the first sub-display row chain, the row chain may be one row chain arbitrarily selected from the display row chain, a first row chain selected from the display row chains or the like, which is not specifically limited by the embodiment of the present disclosure.

S104c6, sequentially distributing the same quantity of information as the information in the information to be displayed to the same quantity of views as the information in one row chain of the first sub-display row chain for display.

In the embodiment of the present disclosure, after the electronic equipment determines the first sub-display row chain for displaying the information to be displayed, the information to be displayed can be displayed in the first sub-display row chain. Specifically, each piece of information in the same quantity of information as the information in the information to be displayed is taken as the preset minimum displaying unit; and the same quantity of information as the information in the information to be displayed is numbered and sorted, and then is sequentially distributed to the same quantity of views as the information in one row chain of the first sub-display row chain for display.

It should be noted that since the quantity of information in the information to be displayed is less than the number of views in one row chain of the first sub-display row chain, when the electronic equipment sequentially distributes the same quantity of information as the information in the information to be displayed to the same quantity of views as the information in one row chain of the first sub-display row chain for display, the same quantity of information as the information in the information to be displayed is sequentially distributed in the same quantity of sorted views as any information in one row chain of the first sub-display row chain.

S104c7, setting the views without displaying information in the first sub-display row chain and the views in the second sub-display row chain to the hidden state, to complete the setting of the display state, thereby displaying the information to be displayed in the display row chains.

In the embodiment of the present disclosure, since the quantity of information in the information to be displayed is less than the number of views in one row chain of the first sub-display row chain, the views without displaying information exist in one row chain of the first sub-display row chain, which refer to the views without displaying information in the first sub-display row chain. In addition, a row chain may exist in the display row chains besides the first sub-display row chain, i.e., if the second sub-display row chain exists in the display row chains, no information is filled into the second sub-display row chain. Therefore, the electronic equipment sets the views without displaying information in the first sub-display row chain and the views in the second sub-display row chains to the hidden state, and sets the display state at this moment, thereby displaying the information to be displayed in the display row chains.

It should be noted that if the second display row chain is absent in the display row chains after the electronic equipment displays the information to be displayed in the first sub-display row chain, when the electronic equipment executes the step S104c7, only the views without displaying information in the first sub-display row chain is set to the hidden state to complete the setting of the display state, thereby displaying the information to be displayed in the display row chains.

In addition, when the quantity of information in the information to be displayed is one, the information to be displayed can also be displayed in other display modes (e.g., the electronic equipment fills the information to be displayed into any view in any row chain) besides the implementation processes described in the steps S104c5-S104c7, which is not specifically limited by the embodiment of the present disclosure.

Exemplarily, when the display row chains contain three row chains and each row chain is composed of three views,

if the information to be displayed acquired by the electronic equipment is one image, the determined quantity of information is one. Since the result of dividing one (the quantity of information) by three (the number of views in the row chains) is 1/3, which is less than one, the electronic equipment selects one row chain (the first sub-display row chain) from the three row chains to display one image. Specifically, one image is filled into a first view, a second view or a third view in one selected row chain, so that two views without displaying information exist in one selected row chain. The electronic equipment sets two views without displaying information in one selected row chain and the views in other two unselected row chains (the second sub-display row chains) of the three row chains to the hidden state here, thereby displaying one image. The display effect of the information to be displayed is as shown in FIG. 5a.

If the information to be displayed acquired by the electronic equipment is two images, the determined quantity of information is two. Since the result of dividing two (the quantity of information) by three (the number of views in the row chains) is 2/3, which is less than one, the electronic equipment selects one row chain (the first sub-display row chain) from three row chains to display two images. Specifically, the two images are numbered and sorted and then are sequentially filled into any two views (the same quantity of views as the information) in one selected row chain, so that one view without displaying information exists in one selected row chain. The electronic equipment sets one view without displaying information in one selected row chain and the views in the other two unselected row chains (the second sub-display row chain) of the three row chains to the hidden state, thereby displaying the two images. The display effect of the information to be displayed is as shown in FIG. 5b.

So far, the technical scheme of displaying the information to be displayed in the display row chains when the first result is not an integer and less than one has been completed.

Finally, when the first result is not an integer and is greater than one, the execution steps S104c8-S104c11 of displaying the information to be displayed in the display row chains are as follows:

S104c8, when the result is not an integer and is greater than one, rounding up the first result to obtain a second result.

In the embodiment of the present disclosure, if the judgment result acquired by the electronic equipment to judge whether the first result is less than one indicates that the first result is greater than one, i.e., when the first result is not an integer and is greater than one, the electronic equipment rounds up the first result to obtain a second result, thereby displaying the information to be displayed in the display row chains according to the second result.

S104c9, acquiring the same number of row chains as the second result from the display row chains to obtain the first sub-display row chains.

In the embodiment of the present disclosure, after the electronic equipment rounds up the first result, it is determined that the number of row chains to be occupied by the information to be displayed in the display row chains is the second result, so that the electronic equipment acquires the same number of row chains as the second result from the display row chains, thereby acquiring the first sub-display row chains. Since the result is greater than one, the first sub-display row chains contain at least two row chains.

S104c10, acquiring a third result of dividing the quantity of information by the second result.

In the embodiment of the present disclosure, after the electronic equipment acquires the first sub-display row chains, the electronic equipment needs to further acquire a third result of dividing the quantity of information by the second result, to specifically determine the display mode of the information to be displayed in the display row chains according to the third result.

S104c11, distributing the information to be displayed to the first sub-display row chains for display according to the third result, and setting the display states of the views without displaying information in the first sub-display row chains and the views in the second sub-display row chain, thereby displaying the information to be displayed in the display row chains.

In the embodiment of the present disclosure, after the electronic equipment acquires the third result, the electronic equipment can distribute the information to be displayed to the first sub-display row chains for display according to the judgment result of whether the third result is an integer, and set the display states of the views without displaying information in the first sub-display row chains and the views in the second sub-display row chain, thereby displaying the information to be displayed in the display row chains.

Further, in the embodiment of the present disclosure, the step S104c11 that the electronic equipment distributes the information to be displayed to the first sub-display row chains for display according to the third result, and sets the display states of the views without displaying information in the first sub-display row chains and the views in the second sub-display row chain, thereby displaying the information to be displayed in the display row chains, specifically includes steps S104c11a-S104c11e.

S104c11a, when the third result is an integer, sequentially distributing the same quantity of information as the information in the information to be displayed to each row chain of the first sub-display row chain uniformly to obtain the sub-information to be displayed corresponding to each row chain of the first sub-display row chains.

In the embodiment of the present disclosure, after the electronic equipment acquires the first sub-display row chain, if the third result is an integer, the electronic equipment sequentially distributes the same quantity of information as the information in the information to be displayed to each row chain of the first sub-display row chains uniformly for display; and the information to be displayed in each row chain is the sub-information to be displayed. Obviously, the sub-information to be displayed contains the same quantity of information as the third result.

S104c11b, sequentially distributing the sub-information to be displayed to the same number of views as the third result in each row chain of the first sub-display row chains for display.

In the embodiment of the present disclosure, after the electronic equipment acquires the sub-information to be displayed corresponding to each row chain of the first sub-display row chains, since the sub-information to be displayed contains the same quantity of information as the third result, the same number of sorted views as the third result are arbitrarily selected from each row chain of the first sub-display row chains corresponding to the sub-information to be displayed; each piece of information in the information to be displayed containing the same quantity of information as the third result is taken as the preset minimum display unit; and the sub-information to be displayed is sequentially distributed to the same number of selected sorted views as the third result for display.

S104c11c, setting the views without displaying information in the first sub-display row chains and the views in the second sub-display row chain to the hidden state, to complete the setting of the display state, thereby displaying the information to be displayed in the display row chains.

In the embodiment of the present disclosure, since the number of views in each row chain of the first sub-display row chains is greater than the quantity of information in the information to be displayed distributed in each row chain, the views without displaying information exist in each row chain of the first sub-display row chains, which are views without displaying information in the first sub-display row chains. Meanwhile, other row chains may exist in the display row chains besides the first sub-display row chains. If second sub-display row chains exist, no information is filled into the second sub-display row chains. Therefore, the electronic equipment sets the views without displaying information in the first sub-display row chains and the views in the second sub-display row chains to the hidden state, to complete the setting of the display state at this moment, thereby displaying the information to be displayed in the display row chains.

It should be noted that if the second display row chains are absent in the display row chains after the electronic equipment displays the information to be displayed in the first sub-display row chains, when the electronic equipment executes the step S104c11c, the electronic equipment only sets the views without displaying information in the first sub-display row chains to the hidden state, to complete the setting of the display state, thereby displaying the information to be displayed in the display row chains.

Exemplarily, when the display row chains contain three row chains and each row chain is composed of three views,

if the information to be displayed acquired by the electronic equipment is four images, the determined quantity of information is four. Since the result of dividing four (the quantity of information) by three (the number of views in the row chain) is 4/3, which is greater than 1, the electronic equipment rounds up 4/3 to obtain two as the second result. At this moment, the electronic equipment selects two row chains (the first sub-display row chains) from the three row chains to display the four images. Specifically, since the result of dividing four (the quantity of information) by two (the second result) is an integer, the electronic equipment numbers and sorts the four images and then sequentially distributes the four images to each of the two selected row chains uniformly. Therefore, two images (the sub-information to be displayed, which is specifically the first two images of the four images corresponding to the first one of the two selected row chains or the last two images of the four images corresponding to the second one of the two selected row chains); and one view without displaying information exists in each of the two selected row chains In addition, one view without displaying information in each of the two selected row chains and the view in one remaining unselected row chain (the second sub-display row chain) of the three row chains are set to the hidden state, thereby displaying the four images. The display effect of the information to be displayed is as shown in FIG. 5d.

So far, the electronic equipment displays the information to be displayed in the display row chains when the third result is an integer.

Further, when the third result is not an integer, the execution steps for the electronic equipment to display the information to be displayed in the display row chains are as follows:

S104c11d, when the third result is not an integer, sequentially distributing each piece of information in the information to be displayed to each view in each row chain of the first sub-display row chains for display.

In the embodiment of the present disclosure, when the electronic equipment determines that the third result is not an integer, the electronic equipment takes each piece of information in the same quantity of information as the information in the information to be displayed as the preset minimum displaying unit, numbers and sorts the same quantity of information as the information in the information to be displayed, and then further sequentially distributes the same quantity of numbered and sorted information as the information in the information to be displayed to each view in each row chain of the first sub-display row chain for display.

S104c11e, setting the views without displaying information in the first sub-display row chain to an invisible state, and setting the views in the second sub-display row chain to a hidden state, to complete the setting of the display states, thereby displaying the information to be displayed in the display row chains, wherein the invisible state indicates that the views are not displayed but the space occupied by the views in the preset display region is reserved.

In the embodiment of the present disclosure, since the number of views in the last row chain of the first sub-display row chain is greater than the quantity of information to be displayed in the last row chain in the information to be displayed, views without displaying information exists in the last row chain of the first sub-display row chain, which refer to the views without displaying information in the first sub-display row chain. At this moment, the electronic equipment will set the views without displaying information in the first sub-display row chain to the invisible state.

It should be noted that the invisible state indicates that the views are not displayed but the space occupied by the views in the preset display region is reserved. For example, the “View” tag (the view) is set to “INVISIBLE” (the invisible state).

In addition, in the embodiment of the present disclosure, if row chains exist in the display row chains other than the first sub-display row chain, i.e., if the second sub-display row chains exist, no information is filled into the second sub-display row chains. Therefore, the electronic equipment sets all the views in the second sub-display row chains to the hidden state, to complete the setting of the display state at this moment, thereby displaying the information to be displayed in the display row chains.

It should be noted that if the second display row chains are absent in the display row chains after the electronic equipment displays the information to be displayed in the first sub-display row chain, when the electronic equipment executes the step S104c11e, the electronic equipment only sets the view without displaying information in the first sub-display row chain to the hidden state, to complete the setting of the display state, thereby displaying the information to be displayed in the display row chains.

Exemplarily, when the display row chains contain three row chains and each row chain is composed of three views,

if the information to be displayed acquired by the electronic equipment is five images, the determined quantity of information is five. Since the result of dividing five (the quantity of information) by three (the number of views in the row chains) is 5/3, which is greater than 1, the electronic equipment rounds up 5/3 to obtain two as the second result. The electronic equipment selects two row chains (the first sub-display row chains) from the three row chains to display the five images at this moment. Specifically, since the third result 5/2 obtained by dividing five (the quantity of information) by two (the second result) is not an integer, the electronic equipment numbers and sorts the five images and then sequentially fills the images into each view in each of the two selected row chains. Therefore, one view without displaying information exists in the last one of the two selected row chains; and the electronic equipment sets one view without displaying information in the last one of the two selected row chains to the invisible state. In addition, the electronic equipment sets the views in one remaining unselected row chain (the second sub-display row chain) of the three row chains to the hidden state, thereby displaying the five images. The display effect of the information to be displayed is as shown in FIG. 5e.

If the information to be displayed acquired by the electronic equipment is seven images, the determined quantity of information is seven. Since the result of dividing seven (the quantity of information) by three (the number of views in the row chains) is 7/3, which is greater than 1, the electronic equipment rounds up 7/3 to obtain three as the second result. The electronic equipment selects three row chains (the first sub-display row chains) from the three row chains to display the seven images at this moment. Specifically, since the third result 7/3 obtained by dividing seven (the quantity of information) by three (the second result) is not an integer, the electronic equipment numbers and sorts the seven images and then sequentially fills the images into each view in each of the three selected row chains. Therefore, two views without displaying information exist in the last one of the two selected row chains; and the electronic equipment sets the two views without displaying information in the last one of the two selected row chains to the invisible state, thereby displaying the seven images. The display effect of the information to be displayed is as shown in FIG. 5g.

If the information to be displayed acquired by the electronic equipment is eight images, the determined quantity of information is eight. Since the result of dividing eight (the quantity of information) by three (the number of views in the row chains) is 8/3, which is greater than 1, the electronic equipment rounds up 8/3 to obtain three as the second result. The electronic equipment selects three row chains (the first sub-display row chains) from the three row chains to display the eight images at this moment. Specifically, since the third result 8/3 obtained by dividing eight (the quantity of information) by three (the second result) is not an integer, the electronic equipment numbers and sorts the eight images and then sequentially fills the images into each view in each of the three selected row chains. Therefore, one without displaying information exists in the last one of the two selected row chains; and the electronic equipment sets one view without displaying information in the last one of the two selected row chains to the invisible state, thereby displaying the eight images. The display effect of the information to be displayed is as shown in FIG. 5h.

In conclusion, in the embodiment of the present disclosure, when the electronic equipment displays the information to be displayed in the display row chains, as shown in FIG. 6, the steps S101-S104 are included, wherein the step S104 includes the steps S104a-S104c; the step S104c includes the steps S104c1-S104c11; and the step S104c11 includes the steps S104c11a-S10411e.

In the embodiment of the present disclosure, in the steps S104c7 and S104c11c, the views without displaying information in the first sub-display row chain are views in each row chain of the first sub-display row chain other than the first view and the last view.

In other words, due to the row chains and the preset display region are provided with left margins or right margins, the electronic equipment preferably takes the views in each row chain of the first sub-display row chain other than the first view and the last view as the views without displaying information, i.e., the electronic equipment sets the views in each row chain of the first sub-display row chain other than the first view and the last view to the hidden state. For example, when the display row chains contain three row chains, each row chain is composed of three views, and all views are numbered 1-9, if the information to be displayed is four images, the electronic equipment displays the four images in the first two of the three row chains, displays two images in each row chain, and sets the views corresponding to No. 2 and No. 5 to “GONE”.

Further, in the embodiment of the present invention, before the electronic equipment combines the maximum number of views displayed in the preset row into one row chain in the step S102, the information display method further includes a step S105:

S105, setting a measurement method of the views.

In the embodiment of the present disclosure, for the views, the electronic equipment sets a method for measuring the length of the displayed information, i.e., sets a measurement method. For example, the electronic equipment rewrites an “onMeasure( )” method in an “ImageView” tag.

Correspondingly, in the embodiment of the present disclosure, the step S102 that the electronic equipment combines the maximum number of views displayed in the preset row into one row chain includes: combining the maximum number of views displayed in the preset row after the measurement method is combined into one row chain.

Further, based on the step S105, the step S104 that the electronic equipment displays the information to be displayed in the display row chains based on the maximum number of views displayed in the preset row includes: firstly, when the information to be displayed is displayed, the electronic equipment acquires a wide length of the information in the information to be displayed by the measurement method; secondly, the electronic equipment sets a high length of the information in the information to be displayed according to the wide length to obtain the set information to be displayed; and finally, the electronic equipment displays the set information to be displayed in the display row chains based on the maximum number of views displayed in the preset row, thereby displaying the information to be displayed in the display row chains.

It should be noted that when the measurement method of views is set, the measurement method of views in the row chains can also be set after obtaining the row chains, which is not specifically limited by the embodiment of the present disclosure.

Exemplarily, when the information to be displayed is information in the form of images, the electronic equipment sets each image in the information to be displayed as a square diagram and then displays the square diagram in the display row chains.

It is understandable that the electronic equipment unifies the specifications of the same quantity of information as the information in the information to be displayed through the set measurement method, thereby improving the display effect of the information to be displayed.

Further, in the embodiment of the present disclosure, before the electronic equipment combines the maximum number of views displayed in the preset row into one row chain in the step S102, the information display method further includes a step S107:

S107, setting the width of the views as a preset threshold.

In the embodiment of the present disclosure, when the electronic equipment sets the preset threshold for the width of the views, for example, the width of the views is set to zero so that the information to be displayed is displayed by the row chain composed of the views, the displayed information to be displayed can be elongated in equal proportion to automatically adapt to the width of the preset display region.

Correspondingly, in the embodiment of the present disclosure, the step S102 that the electronic equipment combines the same number of views as the maximum views displayed in a preset row into one row chain include: the electronic equipment combines the same number of set views as the maximum views displayed in the preset row into one row chain.

It is understandable that the electronic equipment displays the information to be displayed in the row chain using layout constraint, and the layout of various components (views or row chains) is implemented by position constraint, so the information display method provided by the embodiment of the present disclosure has high scalability. For example, a corner marker can be displayed on the displayed image by only setting a constraint between a position of a tag corresponding to the corner marker and a position of the tag corresponding to the displayed image.

In the embodiment of the present disclosure, the electronic equipment can also set a longitudinal chain to obtain the display row chains; and the specific implementation mode is similar to the implementation process described above, and will not be repeated in the embodiment of the present disclosure.

In conclusion, the embodiments of the present disclosure have the following beneficial effects: the information to be displayed is displayed in the display row chains based on the maximum number of views displayed in the preset row, and the display row chains refer to an information layout mode constructed by the row chains with position constraint based on the preset layout requirements, so that the information to be displayed is low in interconnectedness, simple in display mode and unlikely to have errors during display; and less time and power are consumed by the electronic equipment to draw views. Therefore, the display mode of the information to be displayed is low in complexity, high in robustness, high in efficiency and low in power consumption.

The above description is only the embodiment of the present disclosure and the description of the applied technical principles. Those skilled in the art should understand that the scope of disclosure involved in the embodiments of the present disclosure is not limited to the technical solutions formed by the specific combination of the above technical features, and should also cover the technical solutions without departing from the concept of the above disclosed embodiments. Other technical solutions formed by arbitrarily combining the above technical features or their equivalent features. For example, the above-mentioned features and the technical features disclosed in the embodiments of the present disclosure (but not limited to) having similar functions are replaced with each other to form a technical solution.

1. An information display method, comprising:
acquiring the maximum number of views displayed in a preset row and the number of preset rows in a preset display region according to preset layout requirements;
combining the same number of views as the maximum views displayed in the preset row into one row chain;
constructing the same number of row chains as the preset row to obtain display row chains, wherein information is displayed among various row chains of the display row chains by position constraint; and
displaying information to be displayed in the display row chains based on the maximum number of views displayed in the preset row when the information to be displayed is acquired.

2. The method of claim 1, wherein the step of displaying information to be displayed in the display row chains based on the maximum number of views displayed in the preset row comprises:
determining the quantity of information in the information to be displayed according to preset minimum displaying units;
acquiring a first result of dividing the quantity of information by the maximum number of views displayed in the preset row; and
distributing the information to be displayed to a first sub-display row chain of the display row chains for display based on the first result, and setting display states of the views without displaying information in the first sub-display row chain and the views in a second sub-display row chain, thereby displaying the information to be displayed in the display row chains, wherein the second sub-display row chain represents the remaining row chains in the display row chains other than the first sub-display row chain.

3. The method of claim 2, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is an integer, acquiring the same number of row chains as the first result from the display row chains to obtain the first sub-display row chain;
sequentially distributing the same quantity of information as the information in the information to be displayed in each row chain of the first sub-display row chain uniformly to obtain sub-information to be displayed corresponding to each row chain of the first sub-display row chain;
sequentially distributing the sub-information to be displayed to the same number of views as the maximum views displayed in the preset row of each row chain of the first sub-display row chain uniformly for display; and
setting the views in the second sub-display row chain to a hidden state which indicates that the views are not displayed and a space occupied by the views in the preset display region is not reserved, to complete the setting of the display state, thereby displaying the information to be displayed in the display row chains.

4. The method of claim 2, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is not an integer and less than one, acquiring one of the row chains from the display row chains to obtain the first sub-display row chain;
sequentially distributing the same quantity of information as the information in the information to be displayed to the same quantity of views as the information in one row chain of the first sub-display row chain for display; and
setting the views without displaying information in the first sub-display row chain and the views in the second sub-display row chain to the hidden state, to complete the setting of the display state, thereby displaying the information to be displayed in the display row chains.

5. The method of claim 2, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is not an integer and greater than one, rounding up the first result to obtain a second result;
acquiring the same number of row chains as the second result from the display row chains to obtain the first sub-display row chain;
acquiring a third result of dividing the quantity of information by the second result; and
distributing the information to be displayed to the first sub-display row chain for display according to the third result, and setting the display states of the views without displaying information in the first sub-display row chain and the views in the second sub-display row chain, thereby displaying the information to be displayed in the display row chains.

6. The method of claim 5, wherein the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:
when the third result is an integer, sequentially distributing the same quantity of information as the information in the information to be displayed in each row chain of the first sub-display row chain uniformly to obtain the sub-information to be displayed corresponding to each row chain of the first sub-display row chain;
sequentially distributing the information to be displayed to the same number of views as the third result of each row chain of the first sub-display row chain for display; and
setting the views without displaying information in the first sub-display row chain and the views in the second sub-display row chain to the hidden state, to complete the setting of the display state, thereby displaying the information to be displayed in the display row chains.

7. The method of claim 5, wherein the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:
when the third result is not an integer, sequentially distributing each piece of information in the information to be displayed to each view in each row chain of the first sub-display row chain for display;
setting the views without displaying information in the first sub-display row chain to an invisible state and setting the views in the second sub-display row chain to the hidden state, to complete the setting of the display state, thereby displaying the information to be displayed in the display row chains, wherein the invisible state indicates that the views are not displayed but the space occupied by the views in the preset display region is reserved.

8. The method of claim 4, wherein the views without displaying information in the first sub-display row chain refer to the remaining views in each row chain of the first sub-display row chain other than a first view and a last view.

9. The method of claim 1, wherein before combining the same number of views as the maximum views displayed in the preset row into one row chain, the method further comprises:
setting a measurement method of the views; and
correspondingly, the step of combining the same number of views as the maximum views displayed in the preset row into one row chain comprises:
combining the same number of views as the maximum views displayed in the preset row after the measurement method is set into one row chain.

10. The method of claim 9, wherein the step of displaying the information to be displayed in the display row chains based on the maximum number of views displayed in the preset row comprises:
acquiring the width of the information in the information to be displayed by the measurement method when the information to be displayed is displayed;
setting the height of the information in the information to be displayed according to the width to obtain the set information to be displayed; and
displaying the set information to be displayed in the display row chains based on the maximum number of views displayed in the preset row.

11. The method of claim 1, wherein before combining the same number of views as the maximum views displayed in the preset row into one row chain, the method further comprises:
setting the width of the views as a preset threshold; and
correspondingly, the step of combining the same number of views as the maximum views displayed in the preset row into one row chain comprises:
combining the same number of set views as the maximum views displayed in the preset row into one row chain.

12. (canceled)

13. Electronic equipment, comprising:
a communication bus configured to implement communication between a memory and a processor;
the memory configured to store executable instructions; and
the processor configured to implement an information display method comprising:
acquiring the maximum number of views displayed in a preset row and the number of preset rows in a preset display region according to preset layout requirements;
combining the same number of views as the maximum views displayed in the preset row into one row chain;
constructing the same number of row chains as the preset row to obtain display row chains, wherein information is displayed among various row chains of the display row chains by position constraint; and
displaying information to be displayed in the display row chains based on the maximum number of views displayed in the preset row when the information to be displayed is acquired.

14. A computer readable storage medium, on which the executable instructions are stored, when the executable instructions are executed by the processor, cause the processor to implement an information display method comprising:
acquiring the maximum number of views displayed in a preset row and the number of preset rows in a preset display region according to preset layout requirements;
combining the same number of views as the maximum views displayed in the preset row into one row chain;
constructing the same number of row chains as the preset row to obtain display row chains, wherein information is displayed among various row chains of the display row chains by position constraint; and
displaying information to be displayed in the display row chains based on the maximum number of views displayed in the preset row when the information to be displayed is acquired.

15. The electronic equipment of claim 13, wherein the step of displaying information to be displayed in the display row chains based on the maximum number of views displayed in the preset row comprises:
determining the quantity of information in the information to be displayed according to preset minimum displaying units;
acquiring a first result of dividing the quantity of information by the maximum number of views displayed in the preset row; and
distributing the information to be displayed to a first sub-display row chain of the display row chains for display based on the first result, and setting display states of the views without displaying information in the first sub-display row chain and the views in a second sub-display row chain, thereby displaying the information to be displayed in the display row chains, wherein the second sub-display row chain represents the remaining row chains in the display row chains other than the first sub-display row chain.

16. The electronic equipment of claim 15, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is an integer, acquiring the same number of row chains as the first result from the display row chains to obtain the first sub-display row chain;
sequentially distributing the same quantity of information as the information in the information to be displayed in each row chain of the first sub-display row chain uniformly to obtain sub-information to be displayed corresponding to each row chain of the first sub-display row chain;
sequentially distributing the sub-information to be displayed to the same number of views as the maximum views displayed in the preset row of each row chain of the first sub-display row chain uniformly for display; and
setting the views in the second sub-display row chain to a hidden state which indicates that the views are not displayed and a space occupied by the views in the preset display region is not reserved, to complete the setting of the display state, thereby displaying the information to be displayed in the display row chains.

17. The electronic equipment of claim 15, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is not an integer and less than one, acquiring one of the row chains from the display row chains to obtain the first sub-display row chain;
sequentially distributing the same quantity of information as the information in the information to be displayed to the same quantity of views as the information in one row chain of the first sub-display row chain for display; and
setting the views without displaying information in the first sub-display row chain and the views in the second sub-display row chain to the hidden state, to complete the setting of the display state, thereby displaying the information to be displayed in the display row chains.

18. The electronic equipment of claim 15, wherein the step of distributing the information to be displayed to a first sub-display row chain of the display row chains for display based on the first result and setting display states of the views without displaying information in the first sub-display row chain and the views in a second sub-display row chain, thereby displaying the information to be displayed in the display row chains comprises:
when the first result is not an integer and greater than one, rounding up the first result to obtain a second result;
acquiring the same number of row chains as the second result from the display row chains to obtain the first sub-display row chain;
acquiring a third result of dividing the quantity of information by the second result; and
distributing the information to be displayed to the first sub-display row chain for display according to the third result, and setting the display states of the views without displaying information in the first sub-display row chain and the views in the second sub-display row chain, thereby displaying the information to be displayed in the display row chains.

19. The electronic equipment of claim 18, wherein the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:
when the third result is an integer, sequentially distributing the same quantity of information as the information in the information to be displayed in each row chain of the first sub-display row chain uniformly to obtain the sub-information to be displayed corresponding to each row chain of the first sub-display row chain;
sequentially distributing the information to be displayed to the same number of views as the third result of each row chain of the first sub-display row chain for display; and
setting the views without displaying information in the first sub-display row chain and the views in the second sub-display row chain to the hidden state, to complete the setting of the display state, thereby displaying the information to be displayed in the display row chains.

20. The electronic equipment of claim 18, wherein the step of distributing the information to be displayed to the first sub-display row chain for display according to the third result and setting the display states of the views without displaying information in the first sub-display row chain and the views in the second sub-display row chain, thereby displaying the information to be displayed in the display row chains comprises:
when the third result is not an integer, sequentially distributing each piece of information in the information to be displayed to each view in each row chain of the first sub-display row chain for display; and
setting the views without displaying information in the first sub-display row chain to an invisible state and setting the views in the second sub-display row chain to the hidden state, to complete the setting of the display state, thereby displaying the information to be displayed in the display row chains, wherein the invisible state indicates that the views are not displayed but the space occupied by the views in the preset display region is reserved.

21. The electronic equipment of claim 17, wherein the views without displaying information in the first sub-display row chain refer to the remaining views in each row chain of the first sub-display row chain other than a first view and a last view.
